(19) United States
(12) Patent Application Publication
(10) Pub. No.: US 2024/0061121 A1
(43) Pub. Date: Feb. 22, 2024

(54) INTEGRATED LIDAR TRANSMITTER AND RECEIVER

(71) Applicant: Robert Bosch GmbH, Stuttgart (DE)

(72) Inventor: Michael T. White, Livonia, MI (US)

(21) Appl. No.: 17/821,348

(22) Filed: Aug. 22, 2022

(51) Int. Cl. G01S 17/89; G01S 7/481; G01B 11/22; G01S 7/4865

(52) U.S. Cl. CPC G01S 17/89; G01S 7/4815; G01S 7/4816; G01B 11/22; G01S 7/4865

(57) ABSTRACT

A lidar system including an integrated optical transmitter and receiver capable of transmitting light to optically scan the system's field of view (FOV) without employing moving parts and of detecting light produced by reflections of the transmitted light in the FOV. In an example, the integrated optical transmitter and receiver includes a two-dimensional array of semiconductor diodes supported on a common substrate. Each of the semiconductor diodes is individually configurable to operate in a plurality of modes including a light-emitting mode and a photodetector mode. The lidar system includes circuitry to apply forward and reverse electrical biases to different selected subsets of the semiconductor diodes to enable the light-emitting and photodetector modes, respectively. The lidar system may further include circuitry to generate a depth map of the FOV based on time-of-flight measurements performed using the integrated optical transmitter and receiver.

### BACKGROUND

### Field

Various examples relate to optical transceivers and, more specifically but not exclusively, to light sources, optical transmitters, and optical receivers for lidar applications.

### Description of the Related Art

This section introduces aspects that may help facilitate a better understanding of the disclosure. Accordingly, the statements of this section are to be read in this light and are not to be understood as admissions about what is in the prior art or what is not in the prior art.

Light detection and ranging, known as lidar, is a remote-sensing technique that can be used to measure a variety of parameters, for example, distance, velocity, and vibration. Lidar may also be used for high-resolution imaging. Compared to radio-frequency (RF) remote sensing, lidar is capable of providing a finer range resolution and a higher spatial resolution due to the use of a higher carrier frequency and the ability to generate a smaller spot size at the foci. Lidar systems are used in urban planning, hydraulic and hydrologic modeling, geology, forestry, fisheries and wildlife management, three-dimensional (3D) imaging, engineering, coastal management, atmospheric science, meteorology, navigation, autonomous driving, robotic and drone operations, and other applications.

### SUMMARY

Disclosed herein are, among other things, various aspects, features, and embodiments of a lidar system including an integrated optical transmitter and receiver capable of transmitting light to optically scan the system's field of view (FOV) without employing moving parts and of detecting light produced by reflections of the transmitted light in the FOV. In an example, the integrated optical transmitter and receiver includes a two-dimensional array of semiconductor diodes supported on a common substrate. Each of the semiconductor diodes is individually configurable to operate in a plurality of modes including a light-emitting mode and a photodetector mode. The lidar system includes circuitry to apply forward and reverse electrical biases to different selected subsets of the semiconductor diodes to enable the light-emitting and photodetector modes, respectively. The lidar system may further include circuitry to generate a depth map of the FOV based on time-of-flight measurements performed using the integrated optical transmitter and receiver.

One example provides a lidar system comprising a plurality of semiconductor diodes and an electronic controller. The semiconductor diodes are supported on a common substrate, each of the semiconductor diodes being individually configurable to operate in a selected mode of a plurality of modes including a light-emitting mode and a photodetector mode. The electronic controller is configured to select a first subset of the semiconductor diodes to operate in the light-emitting mode and a non-overlapping second subset of the semiconductor diodes to operate in the photodetector mode. The electronic controller is further configured to control changes of the first subset and changes of the non-overlapping second subset based on a scan sequence, the changes of the first subset causing the lidar system to optically scan a field of view thereof. The lidar system is configured to perform a time-of-flight measurement based on relative timing of an optical pulse emitted by the first subset of the semiconductor diodes and a photocurrent generated by the non-overlapping second subset of the semiconductor diodes in response to receiving light produced by reflection of the optical pulse in the field of view.

Another example provides an optical method comprising a step of selecting, via an electronic controller, a first subset of a plurality of semiconductor diodes to operate in a light-emitting mode and a non-overlapping second subset of the plurality of semiconductor diodes to operate in a photodetector mode, the plurality of semiconductor diodes being supported on a common substrate, each of the semiconductor diodes being individually configurable to operate in a selected mode of a plurality of modes including the light-emitting mode and the photodetector mode. The optical method further comprises a step of controlling, via the electronic controller, changes of the first subset and changes of the non-overlapping second subset based on a scan sequence, the changes of the first subset causing a corresponding lidar system to optically scan a field of view thereof. The optical method further comprises a step of performing a time-of-flight measurement based on relative timing of an optical pulse emitted by the first subset of the semiconductor diodes and a photocurrent generated by the non-overlapping second subset of the semiconductor diodes in response to receiving light produced by reflection of the optical pulse in the field of view.

### BRIEF DESCRIPTION OF THE DRAWINGS

Other aspects, features, embodiments, and benefits will become more fully apparent, by way of example, from the following detailed description and the accompanying drawings, in which:

FIG. 1 is a block diagram illustrating a lidar environment, including a lidar system in which various embodiments may be practiced.

FIG. 2 is a schematic cross-sectional side view illustrating an integrated optical transmitter and receiver used in the lidar system of FIG. 1 according to some examples.

FIG. 3 is a schematic diagram illustrating a process optically scanning a field of view using the integrated optical transmitter and receiver of FIG. 2 according to some examples.

FIG. 4 is a schematic diagram illustrating the field of view of the lidar system of FIG. 1 according to some examples.

FIG. 5 is a schematic diagram illustrating transmission of an optical-probe beam and reception of the corresponding reflected optical signal using the integrated optical transmitter and receiver of FIG. 2 according to some examples.

FIG. 6 is a schematic plan view illustrating a diode array used in the integrated optical transmitter and receiver of FIG. 2 according to some examples.

FIG. 7 is a schematic cross-sectional side view illustrating a portion of the diode array of FIG. 6 having one individual semiconductor diode according to some examples.

FIG. 8 is a schematic plan view illustrating the integrated optical transmitter and receiver of FIG. 2 according to some examples.

FIG. 9 is a schematic plan view illustrating the integrated optical transmitter and receiver of FIG. 2 according to other examples.

FIGS. 10A-10F show schematic diagrams illustrating configuration changes of the diode array of FIG. 6 according to some examples.

FIG. 11 is a flowchart illustrating an optical method according to some examples.

### DETAILED DESCRIPTION

In the following description, numerous details are set forth, such as optical device configurations, timings, operations, and the like, in order to provide an understanding of one or more aspects of the present disclosure. It will be readily apparent to a person of ordinary skill in the pertinent art that these specific details are merely examples and not intended to limit the scope of this application.

Some embodiments and examples may benefit from at least some features disclosed in U.S. patent application Ser. No. 17/864,186, which is incorporated herein by reference in its entirety.

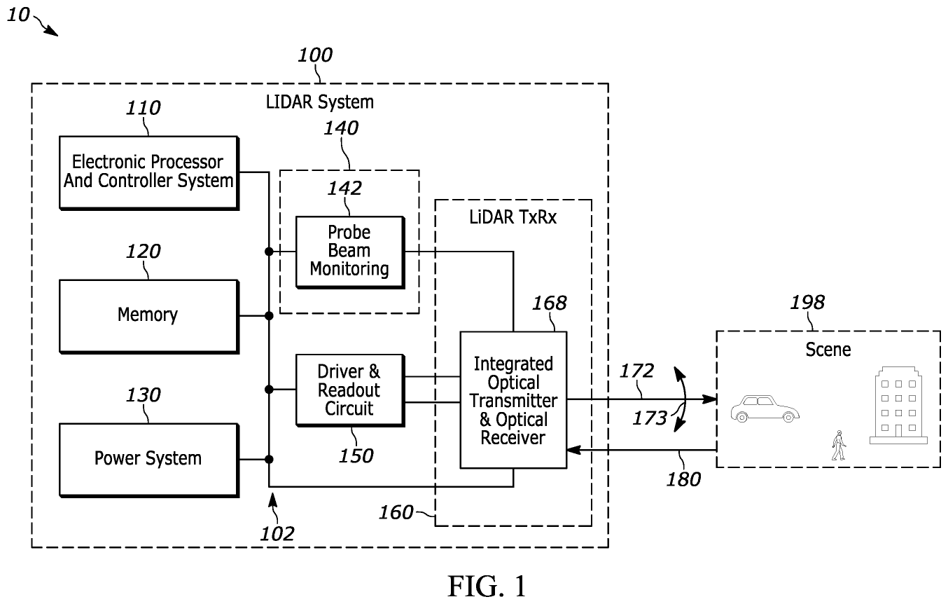

FIG. 1 is a block diagram illustrating a lidar environment 10 according to various examples and aspects. In the example shown, the lidar environment 10 includes a lidar system 100 and a scene 198. The lidar system 100 comprises an electronic controller 110, a memory 120, a power system 130, an optical monitor 140, a driver and readout circuit (DRC) 150, and a lidar transceiver (TxRx) 160. The electronic controller 110 typically includes a processor. In different embodiments, the lidar system 100 may include more or fewer components/elements compared to the number of components/elements explicitly shown in FIG. 1. For example, the lidar transceiver 160 may include various optical elements, such as lenses, mirrors, optical adapters, and the like (not explicitly shown in FIG. 1). Also, the lidar system 100 may perform additional functions compared to the functionality described herein below. In some examples, some of the functionality of the lidar system 100 may be at least partly incorporated into a server or other electronic devices (not explicitly shown in FIG. 1) connected thereto. As illustrated in FIG. 1, different components of the lidar system 100 are electrically connected to each other via one or more control and/or data buses 102 to enable communications between the different components.

The lidar transceiver 160 includes an integrated optical transmitter and receiver (IOTR) 168. In operation, the IOTR 166 generates an optical-probe beam 172 that is directed toward the scene 198. Depending on the intended application, the lidar system 100 may have one or more lenses (not explicitly shown in FIG. 1) arranged to form an optical collimator, an objective, and/or a telescope configured to appropriately shape and direct the optical-probe beam 172. A corresponding optical signal 180 generated by reflections of the optical-probe beam 172 from the scene 198 is captured by the lens system of the lidar transceiver 160 and applied back to the IOTR 168. The IOTR 168 operates to convert the received optical signal 180 into electrical form and applies the resulting electrical signal to the DRC 150 and further to a processor, e.g., 110, for processing. The IOTR 168 further operates to optically scan the scene 198 by moving the light spot of the optical-probe beam 172 across the scene 198 within the field of view (FOV) of the lidar transceiver 160, e.g., as schematically indicated in FIG. 1 by a double-headed arrow 173. Depending on the example, the optical-probe beam 172 may be in the form of a (quasi) continuous-wave (CW) optical beam or a pulsed optical beam. The optical-probe beam 172 may have a fixed carrier frequency or may be frequency-chirped. The carrier frequency can be in the ultraviolet, visible, near infrared, or infrared part of the optical spectrum.

In one example, the IOTR 168 is implemented using an integrated optical device, an opto-electronic chip, or a suitable hybrid opto-electrical assembly. The DRC 150 is configured to provide appropriate electrical currents and/or voltages for operating pertinent circuit components of the IOTR 168 and to receive photocurrents and/or photovoltages generated by the IOTR 168 in response to the optical signal 180. In some examples, the DRC 150 includes one or more transimpedance amplifiers (not explicitly shown in FIG. 1) for handling such photocurrents. In some examples, the DRC 150 also includes one or more analog-to-digital converters for converting the photocurrents and/or photovoltages into digital form. The resulting electrical digital signals are directed, via the bus 102, to the processor/controller 110 for processing.

In one example, the optical monitor 140 includes an optical-beam monitor 142 configured to measure the intensity (optical power) and other pertinent characteristics of the optical-probe beam 172. The measurement/monitoring results generated by the optical monitor 140 are directed, via the bus 102, to the processor/controller 110 and are processed therein to monitor the optical performance of the lidar transceiver 160 and, if needed, to implement configuration changes directed at maintaining the intended level of performance for the lidar system 100.

In a typical conventional lidar system, the scanning light source thereof includes an opto-mechanical scanner in which a mechanically movable mirror or other mechanically movable optical element is used to scan the optical-probe beam across the FOV. In mobile lidar applications in which the corresponding lidar system is mounted on a moving platform, such as a moving car, the scanning light source is typically subjected to relatively strong mechanical vibrations and/or shocks caused by the movement of the platform. Such mechanical vibrations and/or shocks may typically cause an opto-mechanical scanner to break down in a relatively short period of time, e.g., a time period that is shorter than an average lifespan of the corresponding vehicle, thereby disadvantageously requiring the lidar system repair or replacement.

In contrast to convention systems, in one example, the IOTR 168 is capable of optically scanning the FOV of the lidar system 100 without moving parts by employing an addressable 2D diode-element array coupled to an optical FOV adaptor in which optical fibers or waveguides are spatially arranged to provide suitable sampling points for the optical-probe beam 172 within the FOV. The optical FOV adaptor further operates to guide back to the 2D diode-element array the optical signal 180. Depending on the drive currents and/or voltages applied by the DRC 150 to a particular diode element of the 2D array of the IOTR 168, each of the diode elements is reconfigurable to operate as a light emitter or as a photodetector. By selectively placing in the light-emitting configuration and firing different selected diode elements of the 2D array to generate optical pulses for the optical-probe beam 172, different points of the FOV can be sampled at different times, thereby providing the requisite FOV-scanning capability without employing moving parts. By selectively placing other selected diode elements into the photodetector configuration, the corresponding optical signal 180 can be detected using the same 2D diode-element array, without employing a separate dedicated lidar photodetector or optical receiver.

In various examples, the above-indicated features of the IOTR 168 may provide at least two benefits. First, the non-mechanical scanning structure of the IOTR 168 enables the lidar transceiver 160 to be engineered to beneficially withstand mechanical vibrations/shocks for a longer period of time than a functionally comparable opto-mechanical scanner, without breaking down. Second, the dual (i.e., light emitter and photodetector) functionality of the diode elements of the IOTR 168 enables a beneficial size/weight reduction compared to a typical combined size/weight of the separate transmitter and receiver portions of a conventional lidar transceiver. In addition, at least some examples of the lidar transceiver 160 employing the IOTR 168 may be cheaper to manufacture than the functionally comparable conventional lidar transceivers.

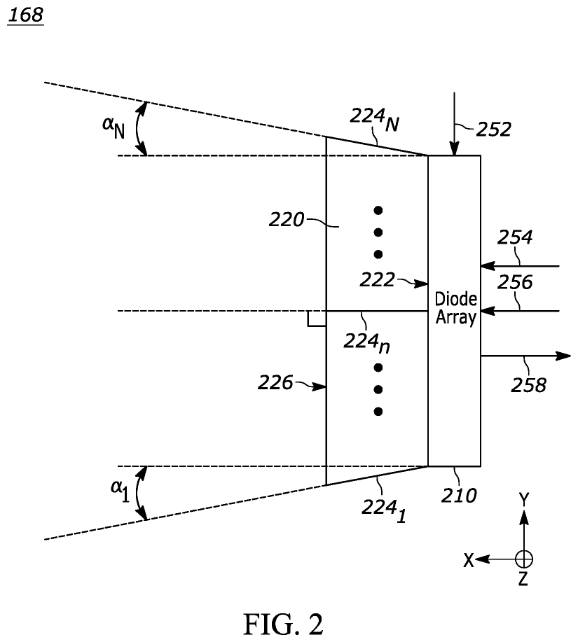

FIG. 2 is a schematic cross-sectional side view illustrating the IOTR 168 according to some examples. The XYZ-coordinate triad shown in FIG. 2 indicates the orientation of the shown cross-section as being parallel to the XY-coordinate plane. The IOTR 168 comprises a diode array 210 and an optical FOV adapter 220 stacked in the X-coordinate direction as indicated in FIG. 2.

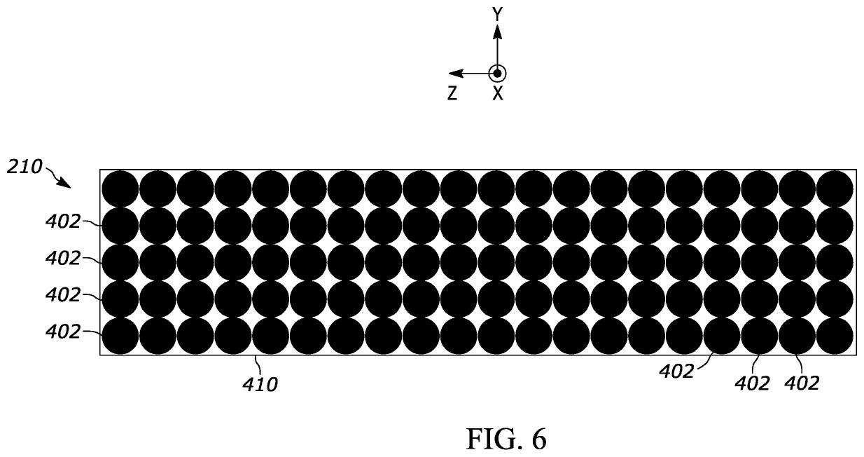

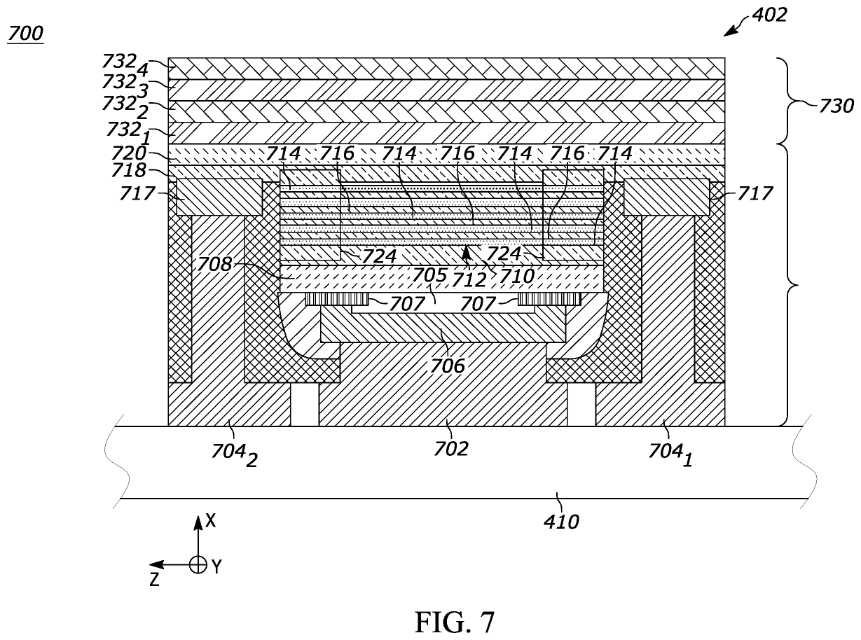

In an example embodiment, the diode array 210 is a substantially planar semiconductor device whose main plain is oriented parallel to the YZ-coordinate plane. Disposed along the main plane is a plurality of semiconductor diodes (not explicitly shown in FIG. 2; e.g., see FIGS. 6-7), each of which is configurable to operate as a light emitter or as a photodetector, e.g., as explained in more detail below in reference to FIG. 7. When configured to operate as a light emitter, an individual semiconductor diode emits light in the direction that is substantially normal to the main plain, i.e., parallel to the X-coordinate axis. When configured to operate as a photodetector, an individual semiconductor diode generates a photocurrent in response to the light guided thereto through the optical FOV adapter 220. Depending on the embodiment, the plurality of semiconductor diodes of the diode array 210 may be arranged in a 2D (e.g., planar) array or in a one-dimensional (e.g., linear) array.

Herein, a “main plane” of an object, such as a die, a substrate, an integrated circuit (IC), or a printed circuit board (PCB) is a plane parallel to a substantially planar surface thereof that has about the largest area among exterior surfaces of the object. This substantially planar surface may be referred to as a main surface. The exterior surfaces of the object that have one relatively large size, e.g., length, but are of much smaller area, e.g., less than one quarter of the main-surface area, are typically referred to as the edges of the object.

To cause an individual one of the semiconductor diodes of the diode array 210 to emit light, that individual semiconductor diode is provided with a first electrical bias and is injected with electrical current. One or more electrical signals 254 generated by the DRC 150 are appropriately routed to one or more selected semiconductor diodes of the diode array 210 for this purpose. Such routing can be implemented, e.g., using circuitry similar to that used in display devices or in solid state memories. The routing of the one or more electrical signals 254 is controlled using one or more control signals 252 generated by the DRC 150 in response to the corresponding control input received from the electronic controller 110. For example, the one or more control signals 252 are used to control the states of switches via which individual ones of the semiconductor diodes of the diode array 210 are connected to or disconnected from the electrical lines supplying the one or more electrical signals 254.

To cause an individual one of the semiconductor diodes of the diode array 210 to generate a photocurrent in response to received light, that individual semiconductor diode is provided with a different second electrical bias. One or more electrical signals 256 generated by the DRC 150 are appropriately routed to one or more selected semiconductor diodes of the diode array 210 for this purpose. Such routing can be implemented, e.g., using circuitry similar to that used in display devices or in solid state memories. The routing of the one or more electrical signals 256 is controlled using the one or more control signals 252 generated by the DRC 150 in response to the corresponding control input received from the electronic controller 110. For example, the one or more control signals 252 are used to control the states of switches via which individual ones of the semiconductor diodes of the diode array 210 are connected to or disconnected from the electrical lines supplying the one or more electrical signals 256. The photocurrents generated by different semiconductor diodes operating in the “photodetector” configurations are typically constructively combined to form a photocurrent 258 that is directed to the DRC 150.

In operation, at a given time, a first subset of the control signals 252 is used to select for light emission (i) a single one of the semiconductor diodes of the diode array 210 or (ii) a subset of two or more semiconductor diodes of the diode array 210. Depending on the injection-current waveform, the light emitted by the selected semiconductor diode(s) of the diode array 210 is pulsed light or (quasi) CW light. At that given time, a second subset of the control signals 252 is similarly used to select for photocurrent generation (i) a different single one of the semiconductor diodes of the diode array 210 or (ii) another non-overlapping subset of two or more semiconductor diodes of the diode array 210. The control signals 252 are changed from time to time to change the subsets of the semiconductor diodes in the diode array 210 selected for light emission and for photocurrent generation.

The FOV adapter 220 comprises a plurality of optical waveguides (e.g., optical fibers) 224, each being end-connected between a first surface 222 of the FOV adapter and an opposite second surface 226 of the FOV adapter. In one instance, the first and second surfaces 222, 226 of the FOV adapter 220 are substantially planar surfaces. The first surface 222 may be parallel to the second surface 226. The surfaces 222 and 226 of the FOV adapter 220 may also be parallel to the main plane (YZ in FIG. 2) of the diode array 210. In some other instances, such parallelism may not be a present, and deviations therefrom may be acceptable or even desirable. In some instances, at least the second surface 226 may be curved and/or have a plurality of micro-lenses attached thereto.

For clarity, only three of the optical waveguides 224 (labeled 224₁, 224ₙ, and 224_{N}, respectively) of the FOV adapter 220, are explicitly shown in FIG. 2. The optical waveguides 224₁ and 224_{N} are located near the opposite edges of the FOV adapter 220. The optical waveguide 224ₙ is located in a middle portion of the FOV adapter 220. In one example, the FOV adapter 220 has a similar waveguide structure extending along the Z-coordinate axis. For example, a cross-section of the FOV adapter 220 taken parallel to the XZ-coordinate plane may generally be similar to the cross-section shown in FIG. 2. The total number of optical waveguides 224 in the FOV adapter 220 depends on the specific instance and is in the range, e.g., between 10 and 10⁴.

The end of an individual optical waveguide 224 located at the first surface 222 of the FOV adapter 220 is optically end-connected to receive light from or direct light to a corresponding one of the semiconductor diodes of the diode array 210. For a semiconductor diode emitting light, a corresponding individual optical waveguide 224 guides the emitted light to the other end thereof located at the second surface 226 of the FOV adapter 220. The guided light then exits through that end of the optical waveguide 224, is collimated, and directed towards the directionally corresponding portion of the FOV. Depending on the specific configuration, a single optical waveguide 224 or a bundle of optical waveguides 224 is optically end-connected to receive light from a respective one of the semiconductor diodes of the diode array 210. In various examples, the number of optical waveguides 224 in such a bundle can range, e.g., from 2 to 100, or be even more than 100. In some examples, some or all of the optical waveguides 224 may be tapered such that the transverse size (e.g., the diameter) of the optical waveguide 224 is larger at the second surface 226 than at the first surface 222 of the FOV adapter 220.

For a semiconductor diode configured to generate photocurrent, a corresponding individual optical waveguide 224 guides a respective received portion of the optical signal 180 from the waveguide end located at the second surface 226 to the other end located at the first surface 222 of the FOV adapter 220. The guided light then exits through that other end of the optical waveguide 224 and is received by the corresponding semiconductor diode that converts the received light into photocurrent. Again, depending on the specific configuration, a single optical waveguide 224 or a bundle of optical waveguides 224 is optically end-connected to guide light to a respective one of the semiconductor diodes of the diode array 210.

End sections of different optical waveguides 224 located at the second surface 226 of the FOV adapter 220 may have different angles with respect to that surface. As an example, FIG. 2 illustrates an instance in which: (i) the end section of the optical waveguide 224₁ has a nonzero angle α₁ with respect to the surface normal of the second surface 226; (ii) the end section of the optical waveguide 224ₙ is orthogonal to the second surface 226; and (iii) the end section of the optical waveguide 224_{N} has a nonzero angle α_{N} with respect to the surface normal of the second surface 226. For the optical waveguides located between the optical waveguides 224₁ and 224ₙ, the angle gradually decreases, in equal or unequal increments, from the nonzero angle α₁ to the zero angle, as the position of the optical waveguide 224 gets farther from the corresponding edge and closer to the middle of the FOV adapter 220. Similarly, for the optical waveguides located between the optical waveguides 224_{N} and 224ₙ, the angle gradually decreases, in equal or unequal increments, from the nonzero angle α_{N} to the zero angle, as the position of the optical waveguide 224 gets farther from the corresponding edge and closer to the middle of the FOV adapter 220. In various examples, the angles α₁ and α_{N} may be the same or different. For example, in one instance, α₁=α_{N}=10°. In such an instance, the angular span of the FOV in the XY-coordinate plane is 20 degrees. The angular span of the FOV in the XZ-coordinate plane can be, e.g., in the range between approximately 5 degrees and approximately 10 degrees. At least some examples of the FOV adapter 220 are fabricated using 3D printing.

In various alternatives, other angular arrangements of the optical waveguides 224 in the FOV adapter 220 are also possible. For example, in one example, the optical waveguides 224₁, 224ₙ, and 224_{N} are oriented as follows: (i) the end section of the optical waveguide 224₁ is orthogonal to the second surface 226; (ii) the end section of the optical waveguide 224 has a nonzero angle αₙ with respect to the surface normal of the second surface 226; and (iii) the end section of the optical waveguide 224_{N} has a larger nonzero angle α_{N} with respect to the surface normal of the second surface 226, i.e., α₁=0 and α_{N}>αₙ>0. For the optical waveguides located between the optical waveguides 224₁ and 224_{N}, the tilt angle gradually increases, in equal or unequal increments, from the zero angle α₁ to progressively larger angles, as the position of the optical waveguide 224 gets farther from the first edge and closer to the second edge of the FOV adapter 220.

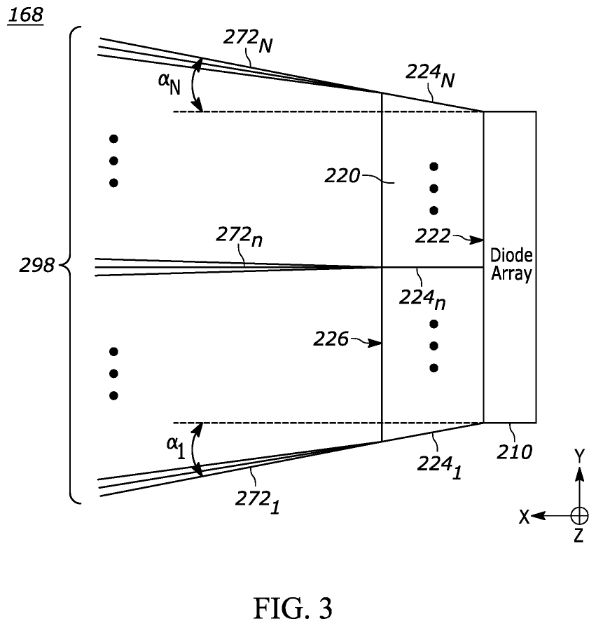

FIG. 3 is a schematic diagram illustrating a process of optically scanning an FOV 298 using the IOTR 168 according to some examples. The view of the IOTR 168 shown in FIG. 3 is the same as the view shown in FIG. 2. The XYZ-coordinate triad shown in FIG. 3 has the same orientation as the XYZ-coordinate triad of FIG. 2 to further clarify the relationship between the views of FIGS. 2 and 3.

The light emitted from the end of the optical waveguide 224₁ is collimated to form an optical-probe beam 272₁ near a boundary of the FOV. The optical axis of the optical-probe beam 272₁ is oriented approximately at the same angle α₁ with respect to the surface normal of the second surface 226 as the end section of the optical waveguide 224₁. The optical-probe beam 272₁ propagates towards the corresponding scene 198 in the FOV 298, illuminates a spot on a surface of an object within the scene, and undergoes specular and/or diffuse reflection thereat to form a corresponding reflected optical beam 180 (also see FIG. 1), which propagates back to the IOTR 168. The light emitted from the end of the optical waveguide 224ₙ is collimated to form an optical-probe beam 272ₙ in the middle of the FOV 298. The optical axis of the optical-probe beam 272ₙ is approximately orthogonal to the second surface 226. The optical-probe beam 272ₙ propagates towards the scene 198 in the FOV 298, illuminates a different respective spot on a surface of the same or different object within the scene, and undergoes specular and/or diffuse reflection thereat to form a corresponding reflected optical beam 180, which again propagates back to the IOTR 168. The light emitted from the end of the optical waveguide 224_{N} is collimated to form an optical-probe beam 272_{N} near another boundary of the FOV 298. The optical axis of the optical-probe beam 272_{N} is oriented approximately at the same angle α_{N} with respect to the surface normal of the second surface 226 as the end section of the optical waveguide 224_{N}. The optical-probe beam 272_{N} propagates towards the scene 198 in the FOV 298, illuminates yet another spot on a surface of the same or different object within the scene, and undergoes specular and/or diffuse reflection thereat to form a corresponding reflected optical beam 180, which again propagates back to the IOTR 168. Other (not explicitly shown in FIG. 3) optical waveguides 224 similarly produce respective optical-probe beams 272, which are reflected from the scene and received by the IOTR 168.

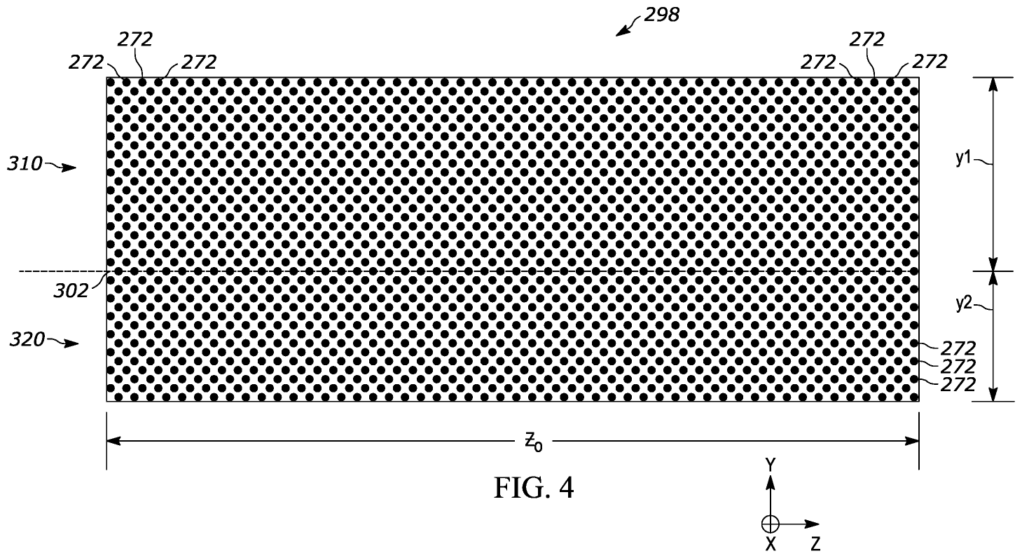

FIG. 4 is a schematic diagram illustrating the FOV 298 according to some examples. The XYZ-coordinate triad shown in FIG. 4 has the same orientation as the XYZ-coordinate triad of FIG. 3 to indicate the spatial relationship between the views shown in FIGS. 3 and 4. In the example shown, the FOV 298 has a generally rectangular shape with an aspect ratio of 2:5. In other examples, the FOV 298 can have other geometric shapes and/or aspect ratios.

Each spot within the example FOV 298 represents a respective one of the optical-probe beams 272 (also see FIG. 3). The total number of optical-probe beams 272 within the FOV 298 is 810. These optical-probe beams 272 are arranged in a 2D array having the size of 18×45. In FIG. 4, a dashed line 302 indicates the division line between two rectangular portions (labeled 310 and 320) of the FOV 298. The portions 310 and 320 have the same width z₀ but different respective heights, labeled y₁ and y₂, respectively, where y₁>y₂. The number of optical-probe beams 272 per unit height in the portion 320 is larger than the number of optical-probe beams 272 per unit height in the portion 310. This example arrangement of optical-probe beams 272 is achieved by using the FOV adapter 220 in which the angle increment between different rows of the optical waveguides is not constant and has a larger (e.g., fixed) value in the part of the FOV adapter 220 corresponding to the portion 310 of the FOV 298 while having a smaller (e.g., another fixed) value in the part of the FOV adapter 220 corresponding to the portion 320 of the FOV 298.

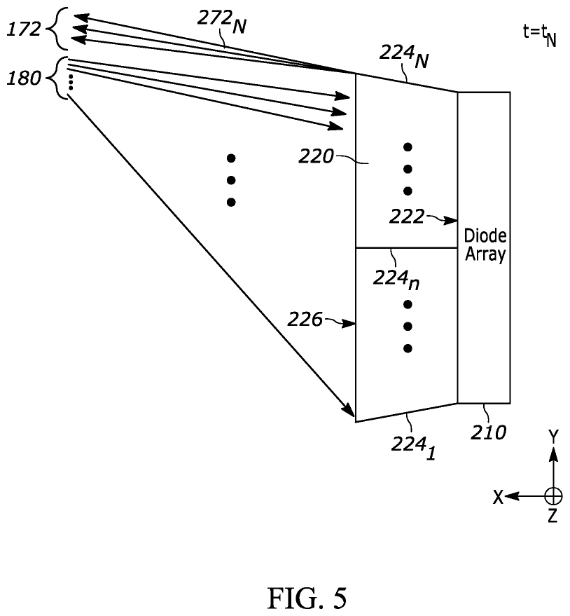

FIG. 5 is a schematic diagram illustrating transmission of an optical-probe beam 172 and reception of the corresponding optical signal 180 using the IOTR 168 according to some examples. For illustration purposes and without any implied limitations, FIG. 5 illustrates an example time t=t_{N} during the process of optically scanning the FOV 298 illustrated in FIG. 3. At that time, the optical-probe beam 172 includes the optical-probe beam 272_{N}. The corresponding optical signal 180 originates from a spot (e.g., the corresponding spot 272, FIG. 4) illuminated by the optical-probe beam 272_{N} in the far field, e.g., on a surface of an object in the scene 198, and is caused by specular and/or diffuse reflection of the probe light from the illuminated spot on that surface.

At the time t=t_{N} illustrated in FIG. 5, a semiconductor diode of the diode array 210 coupled to the optical waveguide 224_{N} of the FOV adapter 220 is configured to emit light, whereas one or more semiconductor diodes coupled to some or all of the other optical waveguides 224 of the FOV adapter 220 are configured to operate as photodetectors. In the example shown, at least the semiconductor diodes coupled to the optical waveguides 224₁ and 224ₙ of the FOV adapter 220 are configured to operate as photodetectors. A person of ordinary skill in the pertinent art will readily understand that, at other times during the process of optically scanning the FOV 298, a corresponding different semiconductor diode of the diode array 210 emits light through the corresponding optical waveguide 224 of the FOV adapter 220 while one or more semiconductor diodes coupled to some or all of the other optical waveguides 224 of the FOV adapter 220 are configured to operate as photodetectors.

FIG. 6 is a plan view illustrating the diode array 210 according to some examples. The XYZ-coordinate triad shown in FIG. 6 has the same orientation as the XYZ-coordinate triad of FIG. 2 to indicate the spatial relationship between the views of FIGS. 2 and 6. In this example, the diode array 210 has one hundred individual semiconductor diodes 402 arranged along a substantially planar main surface of a substrate 410 in a 2D rectangular array, where the semiconductor diodes 402 are arranged in five rows and twenty columns. In various alternatives, the diode array 210 may have a different (from 100) number of semiconductor lasers 402, which may be arranged in a 2D array having any suitable geometric shape.

In the example provided, each of the semiconductor diodes 402 has an approximately circular light-emitting/light-receiving area. When an individual semiconductor diode 402 is configured to emit light, the light is emitted from the approximately circular light-emitting area thereof in the direction that is substantially orthogonal to the main plain of the substrate 410, i.e., approximately along the X-coordinate axis. When an individual semiconductor diode 402 is configured to operate as a photodetector, photocurrent is generated thereby in response to the light impinging onto the approximately circular light-receiving area of that semiconductor diode within the angular cone of acceptance thereof.

FIG. 7 is a cross-sectional side view illustrating a portion 700 of the diode array 210 having one individual semiconductor diode 402 according to some examples. Depending on the electrical configuration, the semiconductor diode 402 can operate as a vertical-cavity surface-emitting laser (VCSEL) or as a photodetector (PD). As already indicated above, each physical instance of the semiconductor diode 402 in the diode array 210 is reconfigurable by operation of the DRC 150. For example, the optical function of each particular semiconductor diode 402 can be changed, e.g., by changing the bias voltage and/or the bias-voltage polarity applied thereto. The semiconductor diode 402 is “surface-coupled” in the sense that, in operation, this device receives or emits light in a direction that is approximately orthogonal to the main plane of the substrate 410, which is parallel to the YZ-coordinate plane in the shown view. Due to this geometry, a relatively large number of semiconductor diodes 402 can be manufactured on the common substrate 410 (e.g., a semiconductor wafer).

In the example shown, the semiconductor diode 402 includes a plurality of layers that are substantially parallel to the YZ-coordinate plane. The direction orthogonal to those layers (i.e., parallel to the X-coordinate axis) may hereafter be referred to as the vertical or surface-normal direction. The directions parallel to those layers may hereafter be referred to as the horizontal or lateral directions. Some of the layers may include two or more sub-layers (not explicitly shown in FIG. 7) that differ from each other in chemical composition and/or the concentration and type of the introduced dopant(s). The semiconductor diode 402 also includes metal electrodes 702, 704₁, and 704₂ electrically connected to some of the layers as described in more detail below. In some examples, the vertical size (or thickness) of the semiconductor diode 402 is smaller than its lateral size (e.g., depth and/or width). In some examples, the metal electrodes 704₁, 704₂ are electrically connected to one another by being parts of the same electrode having, e.g., an O-shape in the plan view of the portion 700 (e.g., if viewed along the X-coordinate axis).

The semiconductor diode 402 comprises an optical resonator defined by mirrors 706 and 730. In some examples, the mirror 706 is a metal (e.g., gold or gold-plated) mirror having relatively high (e.g., >99%) reflectivity at the nominal operating wavelength at the side of the mirror facing up in the view shown in FIG. 7. The mirror 730 is a partially transparent dielectric mirror that enables light of the nominal operating wavelength to be properly coupled into and/or out of the optical resonator. For illustration purposes and without any implied limitations, in the example shown in FIG. 7, the mirror 730 comprises four dielectric layers 732₁-732₄. Alternatively, the mirror 730 can be implemented using a different (from four) number of constituent dielectric layers.

In some examples, the layers 732₁ and 732₃ comprise silicon dioxide, and the layers 732₃ and 732₄ comprise silicon nitride. Alternatively, the mirror 730 can be implemented using dielectric layers of other suitable chemical composition. In some embodiments, the shown mirror 730 can be replaced by a suitable distributed Bragg reflector (DBR) mirror made of semiconductor materials. As known in the pertinent art, a DBR mirror can be formed, e.g., using a stack of semiconductor or dielectric layers, each having a quarter-wavelength thickness, with adjacent layers of the stack having alternating refractive indices.

The optical resonator defined by the mirrors 706 and 730 includes p-type semiconductor layers 708 and 710, n-type semiconductor layers 718 and 720, and a multiple-quantum-well (MQW) structure 712 sandwiched therebetween. The MQW structure 712 comprises a stack of alternating relatively thin layers 714 and 716 made of different respective semiconductor materials. In some examples, the semiconductor materials of the layers 714 and 716 are intrinsic semiconductors. The layer 708 may have a higher dopant concentration than the layer 710, such that the layers 708 and 710 can be referred to as p+ and p layers, respectively. The layer 720 may similarly have a higher dopant concentration than the layer 718, such that the layers 720 and 718 can be referred to as n+ and n layers, respectively. The optical resonator defined by the mirrors 706 and 730 also includes an optional dielectric layer 705 located between the mirror 706 and the semiconductor layer 708. Alternatively, the layer 705 may be absent.

A person of ordinary skill in the art will readily understand that the choices of (i) the semiconductor materials for the layers 708, 710, 714, 716, 718, and 720 and (ii) the vertical distance between the mirrors 706 and 730 depends on the intended operating wavelength of the diode array 210. For example, different embodiments of the diode array 210 can be designed for blue, green, red, and near infrared light, respectively. In some examples, the following semiconductor materials can be used to implement the semiconductor diode 402: (i) Zn-doped In(x)Ga(1-x-y)Al(y)As for the layer 708; (ii) Zn-doped In(x)Al(1-x)As for the layer 710; (iii) In(x)Ga(1-x)As for the layers 714; (iv) In(x)Al(1-x)As for the layers 716; (v) Si-doped In(x)Al(1-x)As for the layer 718; and (vi) Si-doped In(x)Ga(1-x-y)Al(y)As for the layer 720. In other examples, other suitable semiconductor materials and dopants can also be used.

In some examples, the layers 710 and 718 and the MQW structure 712 form a p-i-n diode (also sometimes referred to as a “PIN diode”) that can be electrically biased using the electrodes 702 and 704. Ohmic contact between the electrode 702 and the layer 710 can be created using metal contact pads 707 and the layer 708, e.g., as known in the art. Ohmic contact between the electrode(s) 704 and the layer 718 can be created using metal contact pads 717 and an additional thin n+ or n++ semiconductor layer (not explicitly shown in FIG. 7) located between the contact pads 717 and the layer 718.

To operate the semiconductor diode 402 as a VCSEL, the DRC 150, in response to an instruction received from the electronic controller 110, applies an appropriate forward bias to the PIN diode 710/712/718 using the electrodes 702 and 704. An example of the “forward bias” is an electrical configuration of a semiconductor-junction diode in which the n-type material is at a low potential, and the p-type material is at a high potential. If the forward bias is greater than the intrinsic voltage drop Vₚₙ across the corresponding p-i-n junction, then the corresponding potential barrier can be overcome by the electrical carriers, and a relatively large forward current can flow through the junction. For example, for silicon-based diodes the value of Vₚₙ is approximately 0.7 V. For germanium-based diodes, the value of Vₚₙ is approximately 0.3 V, etc.

To operate the semiconductor diode 402 as a photodetector, the DRC 150 is configured to apply to the PIN diode 710/712/718 an appropriate reverse bias using the electrodes 702 and 704. An example of the “reverse bias” is an electrical configuration of a semiconductor-junction diode in which the n-type material is at a high electrical potential, and the p-type material is at a low electrical potential. The reverse bias typically causes the depletion layer to grow wider due to a lack of electrons and/or holes, which presents a high impedance path across the junction and substantially prevents a current flow therethrough. However, a small reverse leakage current can still flow through the junction in the reverse-bias configuration. The reverse bias creates a relatively large electric field across the p-i-n junction that can separate the electrical carriers (e.g., holes and electrons) generated therein by the absorbed light coupled into the optical resonator of the semiconductor diode 402 through the mirror 730. The separated electrical carriers generate a photocurrent that can be collected and measured by the DRC 150 to determine the light intensity.

In some examples, the lateral dimensions of the optical resonator in the semiconductor diode 402 are defined using ion-implanted regions 724. The ion-implanted regions 724 can be formed by implanting suitable ions (e.g., the hydrogen ions, H⁺) into the MQW structure 712 around its periphery, e.g., as indicated in FIG. 7. The ion-implantation process disrupts, perturbs, and/or destroys the semiconductor lattice in the regions 724, thereby inhibiting the flow of electrical current(s) therethrough and/or hindering the physical processes therein that are pertinent to the above-described optical functions of the semiconductor diode 402.

In some examples, encapsulating and/or filler materials are used as known in the pertinent art to cover and/or fill the gaps (if any) between the various layers, structures, and electrodes of the semiconductor diode 402, thereby providing a substantially monolithic and mechanically robust overall device structure.

In various alternative examples, semiconductor diodes having other structures, i.e., structures that differ from the structure illustrated in FIG. 7, can also be used to implement the semiconductor diodes 402. In some of such examples, MQW structures are absent. Depending on the intended operating wavelength, different suitable semiconductor materials and dopants can be selected for implementing the semiconductor diodes 402.

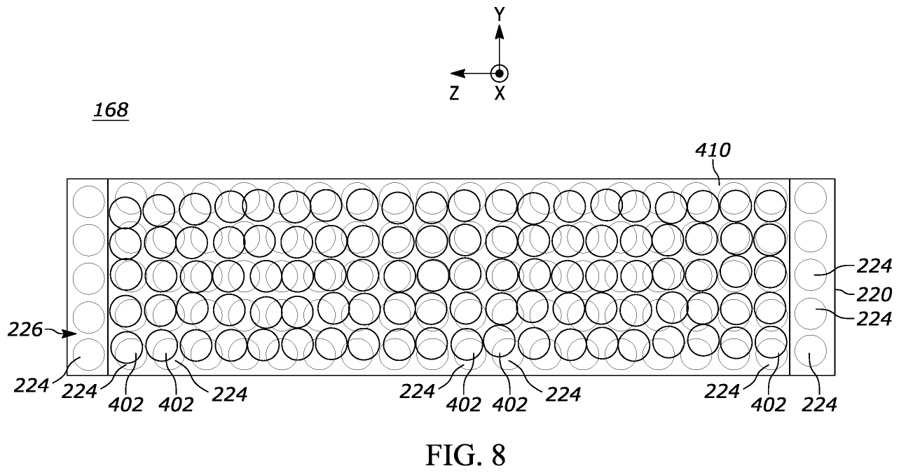

FIG. 8 is a schematic plan view illustrating the IOTR 168 according to some examples. The XYZ-coordinate triad shown in FIG. 8 has the same orientation as the XYZ-coordinate triad of FIG. 2 to indicate the spatial relationship between the views of FIGS. 2 and 8. In the example of FIG. 8, the IOTR 168 has the diode array 210 illustrated in FIG. 6. As described above in reference to FIG. 6, that diode array 210 has one hundred semiconductor diodes 402 arranged along the substrate 410 in a rectangular array. Attached to the laser array 210 is the FOV adapter 220 having one hundred optical waveguides 224. As a consequence, the IOTR 168 of FIG. 8 has a one-to-one ratio of the optical waveguides 224 to the semiconductor diodes 402.

As can be seen in FIG. 8, the second surface 226 of the FOV adapter 220 has a larger area than the area of the substrate 410 occupied by the semiconductor diodes 402. In some examples, the footprint of the FOV adapter 220 on the YZ plane is larger than the footprint of the diode array 210. In the view of FIG. 8, the first surface 222 of the FOV adapter 220 is not directly visible (also see FIG. 2). The ends of the optical waveguides 224 located at the first surface 222 are arranged to be substantially aligned with the corresponding individual semiconductor diodes 402. The corresponding end sections of the optical waveguides 224 located at the first surface 222 may be orthogonal thereto. As already indicated above, the optical waveguides 224 thereafter fan out at various angles thereby causing the ends of most of the optical waveguides 224 located at the second surface 226 to be laterally offset from the vertical projections of the corresponding individual semiconductor diodes 402 onto the second surface 226 as can be seen in FIG. 8. Herein, the term “vertical” means orthogonal to the second surface 226 of the FOV adapter 220 and/or to the main plane of the substrate 410. The term “lateral” means orthogonal to the vertical direction.

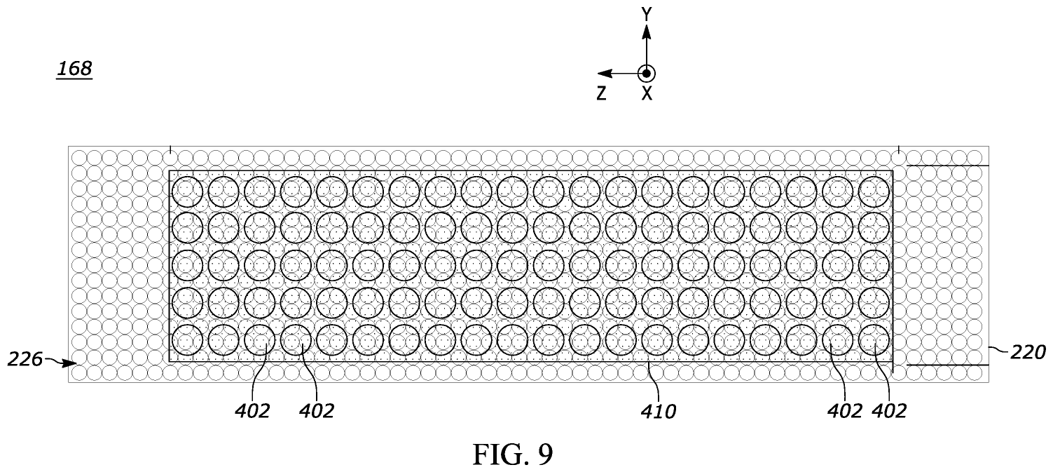

FIG. 9 is a schematic plan view illustrating the IOTR 168 according to other examples. The XYZ-coordinate triad shown in FIG. 9 has the same orientation as the XYZ-coordinate triad of FIG. 2 to indicate the spatial relationship between the views of FIGS. 2 and 9. In the example of FIG. 9, the IOTR 168 has the diode array 210 illustrated in FIG. 6. As described above in reference to FIG. 6, that diode array 210 has one hundred semiconductor diodes 402 arranged along the substrate 410 in a rectangular array. Attached to the diode array 210 is the FOV adapter 220 having nine hundred optical waveguides 224. As a consequence, the IOTR 168 of FIG. 9 has a nine-to-one ratio of the optical waveguides 224 to the semiconductor diodes 402. The surface area of the second surface 226 is larger than the surface area of the substrate 410 occupied by the semiconductor diodes 402.

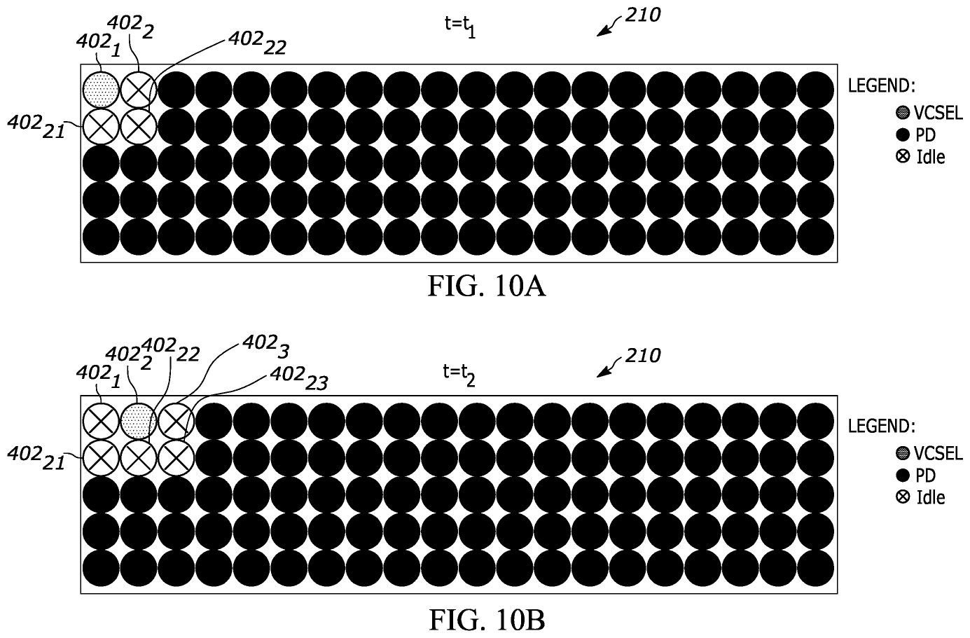

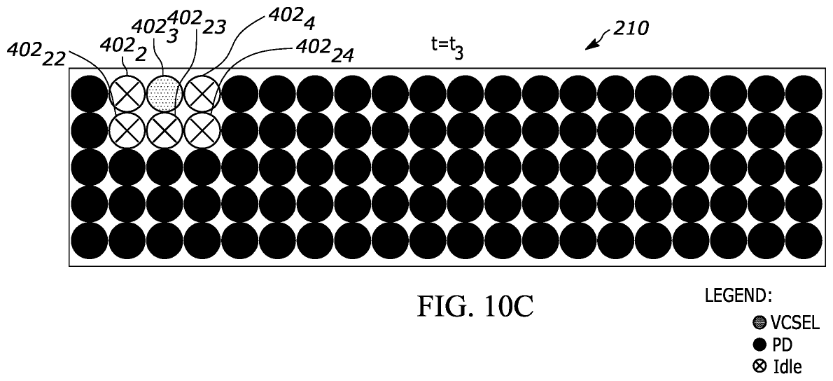

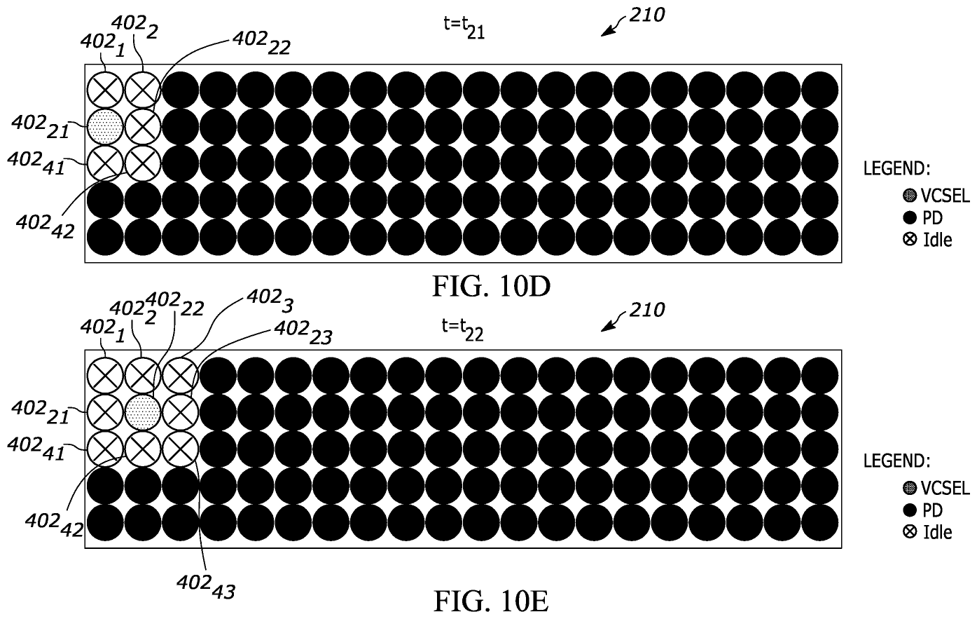

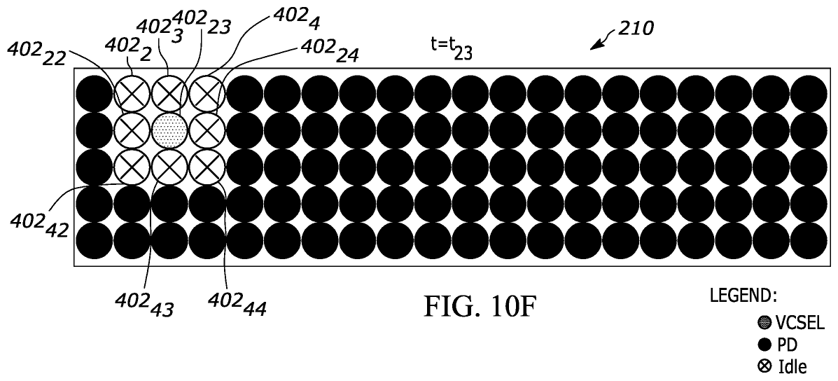

FIGS. 10A-10F are schematic diagrams illustrating configuration changes of the diode array 210 during a representative process of optically scanning the FOV 298 according to some examples. More specifically, each of FIGS. 10A-10F shows the same view of the same diode array 210 (also see FIG. 6) at different times corresponding to one scan frame. At each particular time of the scan frame, each of the semiconductor diodes 402 of the diode array 210 is placed, using the DRC 150, into a respectively selected one of three operating modes: (i) light-emitting (e.g., VCSEL) mode; (ii) PD mode; or (iii) idle mode. As already explained above, in the light-emitting mode, a semiconductor diode 402 is forward-biased by the DRC 150 and emits probe light. In the PD mode, a semiconductor diode 402 is reverse-biased by the DRC 150 and generates photocurrent in response to the received portion of the optical signal 180. In the idle mode, a semiconductor diode 402 is electrically disconnected by the DRC 150 and neither emits light nor generates photocurrent. The different operating modes of the individual semiconductor diodes 402 are pictorially indicated in FIGS. 10A-10F in accordance with the provided legend.

The scan sequence illustrated by FIGS. 10A-10F is in accordance with a raster pattern that effectively causes the optical-probe beam 172 to sweep across the FOV 298 horizontally and vertically at an approximately steady rate. For the example shown, the raster pattern includes: (i) sequentially placing individual semiconductor diodes 402 of the first row of the diode array 210 into the light-emitting mode, starting from the left end of the row and moving toward the opposite end of the row; (ii) sequentially placing individual semiconductor diodes 402 of the second row of the diode array 210 into the light-emitting mode, starting from the left end of the row and moving toward the opposite end of the row; and so on until all individual semiconductor diodes 402 of the last row are sequenced through the light-emitting mode.

FIGS. 10A-10C illustrate an initial portion of the scan frame. At the time t=t₁ illustrated in FIG. 10A, the semiconductor diode 402₁ is in the light-emitting mode and emits light. The semiconductor diodes 402₂, 402₂₁, and 402₂₂ are in the idle mode. The remaining semiconductor diodes of the diode array 210 are in the PD mode and generate photocurrent. The idle diodes 402₂, 402₂₁, and 402₂₂ provide spatial separation between the light-emitting diode 402₁ and the nearby PD diodes to reduce optical crosstalk therebetween. At the time t=t₂ illustrated in FIG. 10B, the semiconductor diode 402₂ is in the light-emitting mode and emits light. The semiconductor diodes 402₁, 402₃, 402₂₁, 402₂₂, and 402₂₃, are in the idle mode. The remaining semiconductor diodes of the diode array 210 are in the PD mode. The idle diodes 402₁, 402₃, 402₂₁, 402₂₂, and 402₂₃ provide spatial separation between the light-emitting diode 402₂ and the nearby PD diodes to reduce optical crosstalk therebetween. At the time t=t₃ illustrated in FIG. 10C, the semiconductor diode 402₃ is in the light-emitting mode and emits light. The semiconductor diodes 402₁, 402₄, 402₂₂, 402₂₃, and 402₂₄ are in the idle mode. The remaining semiconductor diodes of the diode array 210 are in the PD mode. The idle diodes 402₁, 402₄, 402₂₂, 402₂₃, and 402₂₄ provide spatial separation between the light-emitting diode 402₃ and the nearby PD diodes to reduce optical crosstalk therebetween. The scan sequence proceeds in this manner until all semiconductor diodes 402 of the first row of the diode array 210 are sequenced through the light-emitting mode.

FIGS. 10D-10F illustrate the next portion of the scan frame. At the time t=t₂₁ illustrated in FIG. 10D, the semiconductor diode 402₂₁ is in the light-emitting mode and emits light. The semiconductor diodes 402₁, 402₂, 402₂₂, 402₄₁, and 402₄₂ are in the idle mode. The remaining semiconductor diodes of the diode array 210 are in the PD mode and generate photocurrent. The idle diodes 402₁, 402₂, 402₂₂, 402₄₁, and 402₄₂ provide spatial separation between the light-emitting diode 402₂₁ and the nearby PD diodes to reduce optical crosstalk therebetween. At the time t=t₂₂ illustrated in FIG. 10E, the semiconductor diode 402₂₂ is in the light-emitting mode and emits light. The semiconductor diodes 402₁, 402₂, 402₃, 402₂₁, 402₂₃, 402₄₁, 402₄₂, and 402₄₃ are in the idle mode. The remaining semiconductor diodes of the diode array 210 are in the PD mode. The idle diodes 402₁, 402₂, 402₃, 402₂₁, 402₂₃, 402₄₁, 402₄₂, and 402₄₃ provide spatial separation between the light-emitting diode 402₂₂ and the nearby PD diodes to reduce optical crosstalk therebetween. At the time t=t₂₃ illustrated in FIG. 10F, the semiconductor diode 402₂₃ is in the light-emitting mode and emits light. The semiconductor diodes 402₂, 402₃, 402₄, 402₂₂, 402₂₄, 402₄₂, 402₄₃, and 402₄₄ are in the idle mode. The remaining semiconductor diodes of the diode array 210 are in the PD mode. The idle diodes 402₂, 402₃, 402₄, 402₂₂, 402₂₄, 402₄₂, 402₄₃, and 402₄₄ provide spatial separation between the light-emitting diode 402₂₃ and the nearby PD diodes to reduce optical crosstalk therebetween. The scan sequence proceeds in this manner until all semiconductor diodes 402 of the second row of the diode array 210 are sequenced through the light-emitting mode. The scan sequence further proceeds in a similar manner until all semiconductor diodes 402 of the third, fourth, and fifth rows of the diode array 210 are sequenced through the light-emitting mode.

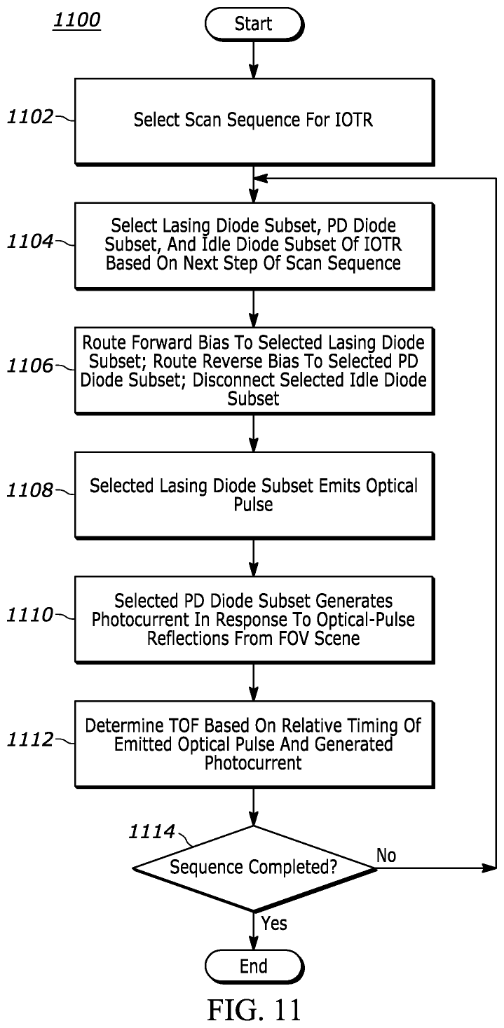

FIG. 11 is a flowchart illustrating an optical method 1100 according to some examples. The method 1100 can be implemented, e.g., using the electronic controller 110, the memory 120, the DRC 150, and the IOTR 168. The method 1100 is described below in continued reference to FIGS. 1-11.

In one example, the method 1100 includes the electronic controller 110 retrieving from the memory 120 a scan sequence (in block 1102). When executed, a scan sequence causes the IOTR 168 to emit a sequence of probe-light pulses to sequentially illuminate different portions of the FOV 298 and to detect the corresponding reflections of the optical pulses from those portions. The memory 120 may have stored therein a plurality of different scan sequences. A suitable one of the different scan sequences may be selected (in block 1102) based on the specific application and configuration of the system 100. A non-limiting example of a raster-type scan sequence that can be selected in some examples of the block 1102 is described above in reference to FIGS. 10A-10F. Other suitable scan sequences can also be used in the system 100.

The method 1100 includes the electronic controller 110 selecting (in block 1104) three non-overlapping subsets of the semiconductor diodes 402 of the diode array 210 based on a next step of the scan sequence loaded up in the block 1102. The three non-overlapping subsets include: (i) a first subset of the semiconductor diodes 402 to operate in the light-emitting mode during the next step of the scan sequence; (ii) a second subset of the semiconductor diodes 402 to operate in the PD mode during the next step of the scan sequence; and (iii) a third subset of the semiconductor diodes 402 to be idle during the next step of the scan sequence. The first subset typically includes one or more semiconductor diodes 402. The second subset typically includes one or more other semiconductor diodes 402. The third subset may include one or more of the semiconductor diodes 402 not belonging to the first and second subsets. In some examples, the third subset may be empty. In such examples, all semiconductor diodes 402 of the diode array 210 are divided between the first and second subsets.

In one example, the method 1100 also includes the electronic controller 110 and the DRC 150 generating (in block 1106) appropriate control signals 252 based on the addresses (e.g., the row number and the column number) of each individual semiconductor diode 402 selected for the first, second, and third subsets in the block 1104. The control signals 252 generated in the block 1106 cause the electrical signals 254, 256 generated by the DRC 150 to be routed to the semiconductor diodes 402 of the first and second subsets, respectively. As indicated above, the electrical signals 254 apply a forward bias to the corresponding semiconductor diodes 402. The electrical signals 256 apply a reverse bias to the corresponding semiconductor diodes 402. The control signals 252 generated in the block 1106 further cause the semiconductor diodes 402 of the third subset to be electrically disconnected to be idle.

In certain examples, the method 1100 also includes the semiconductor diodes 402 of the first subset emitting an optical pulse (in block 1108). Depending on the implementation of the optical FOV adapter 220 and the number of the semiconductor diodes 402 in the first subset, the emitted optical pulse can be in the form of one optical-probe beam 272 or two or more optical-probe beams 272 emitted from the corresponding optical waveguide(s) 224 (also see FIGS. 2-3). For example, a single optical-probe beam 272 is emitted in the block 1108 when the first subset has a single semiconductor diode 402, and the IOTR 168 has a one-to-one ratio of the optical waveguides 224 to the semiconductor diodes 402.

The method 1100 may also include the semiconductor diodes 402 of the second subset generating photocurrent(s) (in block 1110). These photocurrents are generated by the semiconductor diodes 402 of the second subset in response to the respective received portions of the optical signal 180 caused by reflections, from the surfaces within the FOV 298, of the optical pulse emitted by the semiconductor diode(s) 402 of the first subset in the block 1108. When the second subset has two or more semiconductor diodes 402, the photocurrents generated by the individual semiconductor diodes 402 of the second subset are constructively combined in the diode array 210 to generate the corresponding combined photocurrent 258 that is then directed to the DRC 150, digitized therein, and further directed to the electronic controller 110 (in block 1110).

The method 1100 may also include the electronic controller 110 determining (in block 1112) the time difference between the optical-pulse emission in the block 1108 and the reflected-pulse arrival in the block 1110. This time difference is often referred to as the time of flight (TOF) and can be converted into the depth information for the corresponding portion of the FOV 298 as known in the art. Therefore, by executing in full the scan sequence selected in the block 1102, a depth map of the FOV 298 can be generated by the system 100, e.g., during postprocessing of the TOF measurements corresponding to different steps of the scan sequence.

The method 1100 may also include the electronic controller 110 determining (in decision block 1114) whether or not the scan sequence selected in the block 1102 is completed. When the electronic controller 110 determines that the scan sequence is not completed, the processing of the method 1100 is looped back to the block 1104. Otherwise, the processing of the method 1100 is terminated.

It is to be understood that the above description is intended to be illustrative and not restrictive. Many implementations and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future examples. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed subject matter incorporate more features than are expressly recited in each claim. Rather, as the following claims reflect, inventive subject matter lies in fewer than all features of a single disclosed example. Thus, the following claims are hereby incorporated into the Detailed Description, with each claim standing on its own as a separately claimed subject matter.

Unless explicitly stated otherwise, each numerical value and range should be interpreted as being approximate as if the word “about” or “approximately” preceded the value or range.

The use of figure numbers and/or figure reference labels (if any) in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner. In addition, unless explicitly indicated otherwise, the articles “a” and “an” should be interpreted as indicating one or more.

Unless otherwise specified herein, in addition to its plain meaning, the conjunction “if” may also or alternatively be construed to mean “when” or “upon” or “in response to determining” or “in response to detecting,” which construal may depend on the corresponding specific context. For example, the phrase “if it is determined” or “if [a stated condition] is detected” may be construed to mean “upon determining” or “in response to determining” or “upon detecting [the stated condition or event]” or “in response to detecting [the stated condition or event].”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

The functions of the various elements shown in the figures, including any functional blocks labeled as “electronic processors” and/or “controllers,” may be provided through the use of dedicated hardware (for example, an ASIC) as well as hardware capable of executing software in association with appropriate software (for example, a microprocessor). When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and nonvolatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

As used in this application, the terms “circuit,” “circuitry” may refer to one or more or all of the following: (a) hardware-only circuit implementations (such as implementations in only analog and/or digital circuitry); (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

What is claimed is:

1. A lidar system, comprising:
a plurality of semiconductor diodes supported on a common substrate, each of the semiconductor diodes being individually configurable to operate in a selected mode of a plurality of modes including a light-emitting mode and a photodetector mode; and
an electronic controller configured to:
select a first subset of the semiconductor diodes to operate in the light-emitting mode and a non-overlapping second subset of the semiconductor diodes to operate in the photodetector mode; and
control changes of the first subset and changes of the non-overlapping second subset based on a scan sequence, the changes of the first subset causing the lidar system to optically scan a field of view thereof; and
wherein the lidar system is configured to perform a time-of-flight measurement based on relative timing of an optical pulse emitted by the first subset of the semiconductor diodes and a photocurrent generated by the non-overlapping second subset of the semiconductor diodes in response to receiving light produced by reflection of the optical pulse in the field of view.

2. The lidar system of claim 1, further comprising a drive and readout circuit connected to the plurality of semiconductor diodes and configured to apply a forward electrical bias to the first subset of the semiconductor diodes and further configured to apply a reverse electrical bias to the second subset of the semiconductor diodes.

3. The lidar system of claim 2,
wherein the drive and readout circuit is further configured to generate a stream of digital values representing the photocurrent and direct the stream of digital values to the electronic controller; and
wherein the electronic controller is further configured to determine the relative timing based on the stream of digital values.

4. The lidar system of claim 1,
wherein the plurality of modes includes an idle mode; and
wherein the electronic controller is further configured to:
select a non-overlapping third subset of the semiconductor diodes to be in the idle mode; and
control changes of the non-overlapping third subset based on the scan sequence.

5. The lidar system of claim 4, wherein the non-overlapping third subset of the semiconductor diodes has a geometric shape configured to provide spatial separation between the first subset of the semiconductor diodes and the non-overlapping second subset of the semiconductor diodes on the common substrate.

6. The lidar system of claim 1, wherein each of the semiconductor diodes comprises a respective p-i-n semiconductor diode.

7. The lidar system of claim 1, further comprising an optical adapter having a first surface and an opposite second surface, the first surface being adjacent and along the plurality of semiconductor diodes; and
wherein the optical adapter includes a plurality of optical waveguides, each of the optical waveguides having a respective first end at the first surface and a respective second end at the second surface, the plurality of optical waveguides being optically end-connected to the plurality of semiconductor diodes.

8. The lidar system of claim 7,
wherein an end section of a first optical waveguide of the plurality of optical waveguides is oriented at a first nonzero angle with respect to a surface normal of the second surface, said end section of the first optical waveguide being adjacent to the respective second end thereof; and
wherein an end section of a second optical waveguide of the plurality of optical waveguides is oriented at a different second nonzero angle with respect to the surface normal, said end section of the second optical waveguide being adjacent to the respective second end thereof.

9. The lidar system of claim 8, wherein an end section of a third optical waveguide of the plurality of optical waveguides adjacent to the respective second end thereof is orthogonal to the second surface.

10. The lidar system of claim 8, wherein an end section of at least a third optical waveguide of the plurality of optical waveguides adjacent to the respective second end thereof is oriented at a third nonzero angle with respect to the surface normal, the third nonzero angle being larger than the first nonzero angle and being smaller than the different second nonzero angle.

11. The lidar system of claim 7,
wherein each of the optical waveguides comprises a respective optical fiber; and
wherein the respective optical fibers are fixedly attached to each other to form a monolithic structure of the optical adapter.

12. The lidar system of claim 7, wherein the optical waveguides are arranged in the optical adapter such that each of the semiconductor diodes is optically coupled to emit light and receive light through a respective single one of the optical waveguides.

13. The lidar system of claim 7, wherein the optical waveguides are arranged in the optical adapter such that each of the semiconductor diodes is optically coupled to emit light and receive light through a respective set of the optical waveguides, each of the respective sets having an equal fixed number of the optical waveguides, the equal fixed number being in a range from 2 to 100.

14. The lidar system of claim 7, wherein the first surface of the optical adapter has a smaller surface area than the opposite second surface.

15. The lidar system of claim 1, further comprising circuitry configured to cause the first subset corresponding to one step of the scan sequence and the first subset corresponding to another step of the scan sequence to emit respective optical pulses at different respective times.

16. The lidar system of claim 1, wherein the plurality of semiconductor diodes has at least ten semiconductor diodes on the common substrate.

17. An optical method, comprising:
selecting, via an electronic controller, a first subset of a plurality of semiconductor diodes to operate in a light-emitting mode and a non-overlapping second subset of the plurality of semiconductor diodes to operate in a photodetector mode, the plurality of semiconductor diodes being supported on a common substrate, each of the semiconductor diodes being individually configurable to operate in a selected mode of a plurality of modes including the light-emitting mode and the photodetector mode;
controlling, via the electronic controller, changes of the first subset and changes of the non-overlapping second subset based on a scan sequence, the changes of the first subset causing a corresponding lidar system to optically scan a field of view thereof; and
performing a time-of-flight measurement based on relative timing of an optical pulse emitted by the first subset of the semiconductor diodes and a photocurrent generated by the non-overlapping second subset of the semiconductor diodes in response to receiving light produced by reflection of the optical pulse in the field of view.

18. The optical method of claim 17, further comprising controlling, via the electronic controller, a drive and readout circuit connected to the plurality of semiconductor diodes to apply a forward electrical bias to the first subset of the semiconductor diodes and to apply a reverse electrical bias to the second subset of the semiconductor diodes.

19. The optical method of claim 17, further comprising:
selecting, via the electronic controller, a non-overlapping third subset of the semiconductor diodes to be in an idle mode of the plurality of modes; and
controlling, via the electronic controller, changes of the non-overlapping third subset based on the scan sequence.

20. The optical method of claim 17, further comprising selecting, via the electronic controller, the non-overlapping third subset to have a geometric shape configured to provide spatial separation between the first subset of the semiconductor diodes and the non-overlapping second subset of the semiconductor diodes on the common substrate.
